(19) United States
(12) Patent Application Publication
(10) Pub. No.: US 2023/0305896 A1
(43) Pub. Date: Sep. 28, 2023

(54) CLOUD SERVICE FOR ORCHESTRATING WORKFLOW OF JOBS

(71) Applicant: SAASGLUE LLC, STAR, ID (US)

(72) Inventors: Richard Charles WOOD, St. George, UT (US); Stephen Bartlett WOOD, Cedar Hills, UT (US)

(21) Appl. No.: 17/701,512

(22) Filed: Mar. 22, 2022

(51) Int. Cl. H04L 9/08; H04L 67/02; G06F 9/50

(52) U.S. Cl. CPC G06F 9/5038; G06F 9/5077; H04L 9/0825; H04L 67/02

(57) ABSTRACT

A method or a server computer system is configured for orchestrating one or more jobs that are to be executed by one or more agent computer systems. Each job includes one or more tasks. The server computer system is configured to establish a secure and ongoing connection with the one or more agent computer systems over a network. For each task, the server computer system is configured to select at least one of the one or more agent computer systems and send the task to the at least one agent computer system, causing the at least one agent computer system to execute the task. In response to executing the task by the at least one agent computer system, the server computer system is configured to receive an execution status of the task from the at least one agent computer system.

### CROSS-REFERENCE TO RELATED APPLICATION

NA.

### BACKGROUND

Automating workflows across computing environments, such as automating a workflow through several corporate subnets and private cloud services, is challenging. In some cases, it takes several months of requisitioning resources, and then it will take more time to set up servers, install plugins, and test it all. Even after everything is set up, additional technical issues and delays may occur due to the securities of different networks and/or compatibility of different environments.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

This Summary is provided to introduce a selection of concepts in a simplified form that is further described below in the Detailed Description. This Summary is not intended to identify key features or essential features of the claimed subject matter, nor is it intended to be used as an aid in determining the scope of the claimed subject matter.

The embodiments described herein are related to a system including (1) a cloud service provided at a server computer system and (2) one or more agents installed on one or more agent computer systems. The cloud service is configured to orchestrate job objects (also referred to as jobs) that are being executed or to be executed by the one or more agent computer systems. The jobs are used to define workflows, which make the cloud service a powerful automation engine. Jobs can reach across all kinds of networks, devices, languages, and applications and be incorporated into unified, well-orchestrated workflows.

The agent computer systems can be physical machines, virtual machines, or containers; they can be located in many types of environments including corporate networks, private clouds, and more; and they can be operating under different operating systems, such as (but not limited to) Windows, Linux, Mac, Alpine, and/or Free BSD.

Once an agent is installed on an agent computer system, the agent is configured to establish a secure and ongoing connection with the cloud service, and the software agent is configured to send a heartbeat to the cloud service. In some embodiments, the secure and ongoing connection is established via Hypertext Transfer Secure Protocol (HTTPS).

In particular, the cloud service is configured to organize and manage jobs in a hierarchical manner. In embodiments, each job includes one or more task objects (also referred to as a task). For each task, the cloud service is configured to select at least one of the one or more agent computer systems, and send the task to the at least one agent computer system, causing the at least one agent computer system to execute the task. After the at least one agent computer system executes (or tries to execute) the task, the at least one agent is configured to send status of the task to the cloud service, and the cloud service is configured to receive status of the task from the at least one agent computer system.

In some embodiments, when a first agent computer system among the one or more agent computer systems that was selected to execute a task fails, the cloud service may be configured to select a second agent computer system among the one or more agent computer systems, and send the task to the second agent computer system, causing the second computer system to execute the task. After the second agent computer system executes (or tries to execute) the task, the second agent computer system is configured to send a status of the task to the cloud service, and the cloud service is configured to receive the status of the task from the second agent computer system. In the case of a service task, the service task, initially executed on one agent, may be automatically sent to another agent. This automatic sending may occur if the agent host machine goes down while the service task is in a running state.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not, therefore, to be considered to be limiting in scope, embodiments will be described and explained with additional specificity and details through the use of the accompanying drawings in which:

FIG. 1 illustrates an example of a system including a server computer system and multiple agent computer systems configured to communicate with each other over a network;

FIGS. 2A, 2B, and 2C illustrate an example user interface provided by a cloud service for generating an agent for an agent computer system;

FIGS. 3A and 3B illustrate an example user interface configured to generate a new key-secret pair;

FIG. 4 illustrates an example structure of a job;

FIG. 5 illustrates an example workflow of a job;

FIGS. 6A-6C illustrate an example user interface configured to allow a user to create a job and its workflow;

FIG. 7 illustrates an example user interface showing a home screen of a cloud service that provides a general status of different agents and jobs associated with the user;

FIG. 8 illustrates an example user interface showing statuses of multiple jobs in a list;

FIG. 9 illustrates an example user interface showing a list of agents associated with a user;

FIG. 10 illustrates an example user interface showing a console that allows a user to review, edit, create, and/or run a script object;

FIG. 11 illustrates an example user interface showing a list of artifacts shared for a team;

FIG. 12 illustrates an example user interface showing a list of variables shared for a team;

FIG. 13 illustrates an example user interface allowing a user to set email alerts and/or slack alerts when a task is interrupted, a task is failed, and/or a job is completed;

FIG. 14 illustrates an example user interface showing a list of script objects;

FIG. 15 illustrates a flowchart of an example method for orchestrating one or more jobs that are executed or to be executed by one or more agent computer systems;

FIG. 16 illustrates a flowchart of an example method for managing a service job having a single task that is executed or to be executed by one or more agent computer systems;

FIG. 17 illustrates a flowchart of an example method for securely connecting to an agent computer system over a network;

FIG. 18 illustrates an example architecture of a server computer system in which the principles described herein may be employed; and

FIG. 19 illustrates an example architecture of an agent computer system in which the principles described herein may be employed.

### DETAILED DESCRIPTION

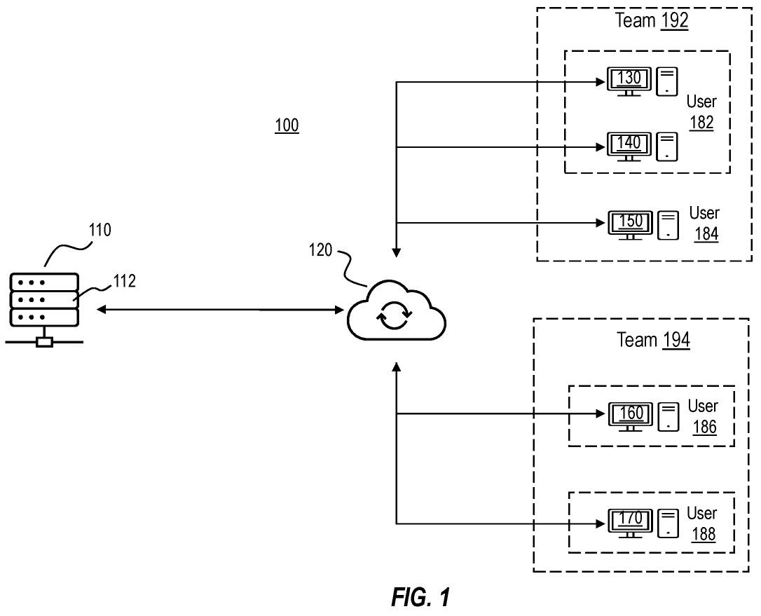

The principles described herein are related to a system, including (1) a cloud service provided at a server computer system and (2) one or more agents installed on one or more agent computer systems. FIG. 1 illustrates an example of a system 100, including a server computer system 110 and multiple agent computer systems 130, 140, 150, 160, 170. The server computer system 110 is configured to communicate with the multiple agent computer systems 130, 140, 150, 160, 170 via a network 120.

The server computer system 110 provides a cloud service 112. The cloud service 112 is configured to orchestrate job objects (also referred to as jobs) that are being executed or to be executed by the one or more agent computer systems 130, 140, 150, 160, 170. The agent computer systems 130, 140, 150, 160, 170 are associated with different users 182, 184, 186, 188, and/or teams 192, 194. For example, as illustrated, agent computer systems 130, 140 are associated with user 182, agent computer system 150 is associated with user 184, agent computer system 160 is associated with user 186, and agent computer system 170 is associated with user 188. Further, users 182 and 184 are associated with team 192; as such, agent computer systems 130, 140, 150 (associated with users 182, 184) are also associated with team 192. Similarly, users 186 and 188 are associated with team 194; as such, agent computer systems 160, 170 are also associated with team 194.

The jobs are used to define workflows, which make the cloud service 112 a powerful automation engine. Job objects can reach across all kinds of networks, devices, languages, and applications and be incorporated into unified, well-orchestrated workflows. For example, when user 182 creates a job, the server computer system 110 is configured to select an agent computer system to execute the job. In some embodiments, the server computer system 110 is configured to select one of the agent computer systems 130, 140 associated with the user 182 who created the job. In some embodiments, the server computer system 110 is configured to select one of the agent computer systems 130, 140, 150 that are associated with team 192 with which the user 182 is also associated.

In some embodiments, the cloud service 112 can orchestrate executions of any script, and it can even orchestrate executions of compiled code. The software agent installed on an agent computer system doesn’t run the scripts; instead, it hands the scripts off to the correct interpreter on the agent computer system for execution and collects the output.

The agent computer systems 130, 140, 150, 160, 170 can be physical machines, virtual machines, containers, or embedded platforms; they can be located in many types of environments, including (but not limited to) corporate networks, private clouds, and more; and they can be operating under different operating systems, such as (but not limited to) Windows, Linux, Mac, Alpine, and/or FreeBSD.

Once an agent is installed on an agent computer system 130, 140, 150, 160, 170, the software agent is configured to establish a secure and ongoing connection with the cloud service 112, and the software agent is configured to send a heartbeat to the cloud service 112. In some embodiments, the secure and ongoing connection is established via Hypertext Transfer Secure Protocol (HTTPS). In some embodiments, the secure and ongoing connection is established via Hypertext Transfer Secure Protocol (HTTPS).

In some embodiments, establishing the secure and ongoing connection with the one or more agent computer systems 130, 140, 150, 160, 170 over the network 120 includes is performed via a software agent executing on the one or more agent computer systems 130, 140, 150, 160, 170.

In some embodiments, each of the one or more agent computer systems 130, 140, 150, 160, 170 is associated with a key-secret pair, and the association of each agent computer system and the corresponding key-secret pair are registered with the cloud service 112. The execution of the software agent is executed with the key-secret pair as a configuration of the software agent. The establishing the secure and ongoing connection with the one or more agent computer systems 130, 140, 150, 160, 170 over the network 120 includes for each of the one or more agent computer systems 130, 140, 150, 160, 170, verifying the key-secret pair of the software agent is the corresponding key-secret pair registered with the cloud service 112. In some embodiments, a key-secret pair is generated by the cloud service 112. In some embodiments, a software agent is generated after a user is authenticated at the agent computer system.

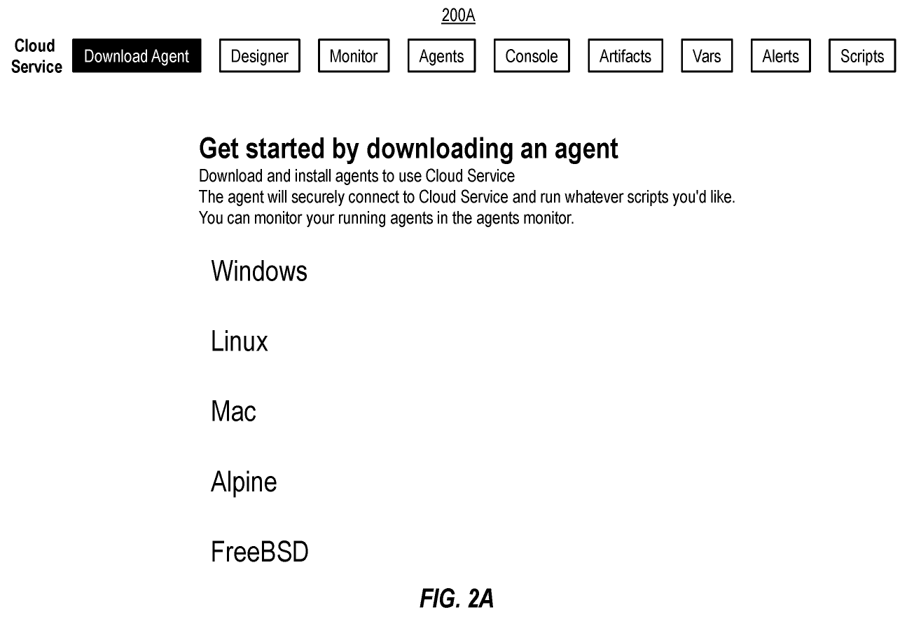

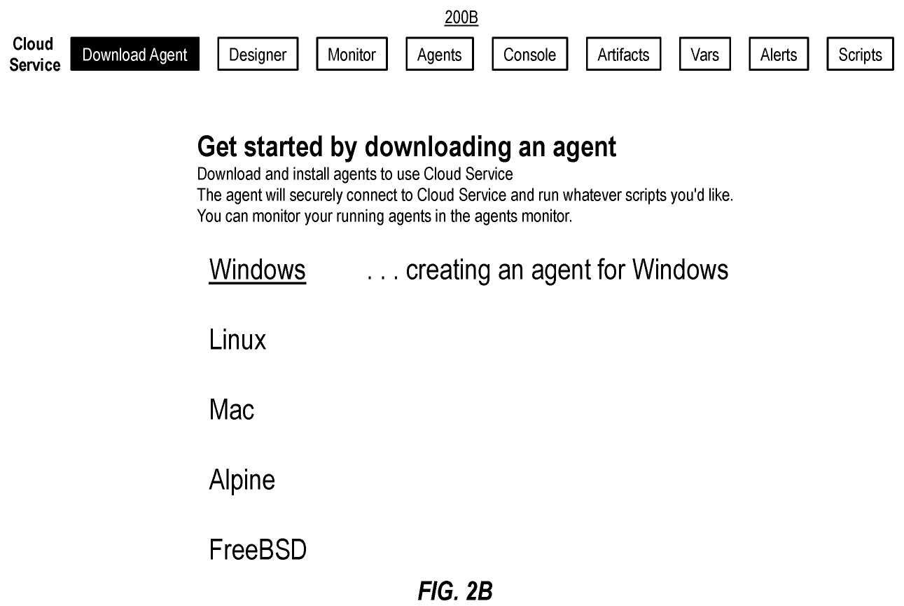

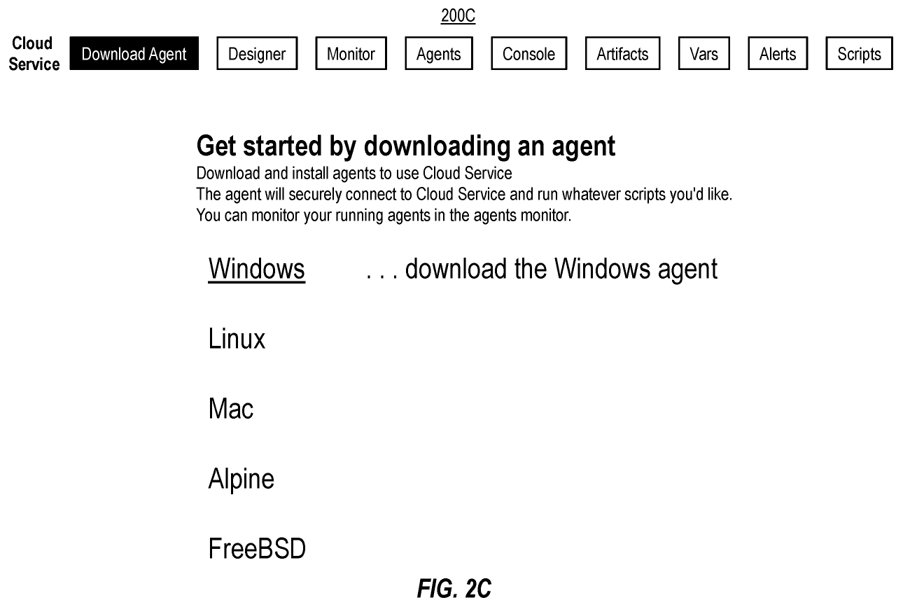

FIGS. 2A, 2B, and 2C illustrate an example user interface 200A, 200B, 200C provided by the cloud service 112 for generating a software agent for an agent computer system 130, 140, 150, 160, 170. In some embodiments, the cloud service user interface 200A, 200B, 200C is provided in a browser. After a user logs in to their account, the user can click the “Download Agent” link. After that, the browser would display the cloud service user interface 200A showing a list of operating systems, such as (but not limited to) Windows^{®}, Linux^{®}, Mac^{®}, Alpine^{®}, and/or FreeBSD^{®}, that the user’s computer system runs. The user can then select one of the operating systems. For example, when the user selects Windows^{®}, the cloud service 112 is configured to create a software agent for a computer system that runs Windows^{®} operating system, and user interface 200B will be displayed at the browser. Once the software agent for Windows^{®} is created, the cloud service user interface is transitioned from 200B to 200C, through which the user can download the Windows^{®} agent to the user’s computer system. When the user’s computer system executes the downloaded agent, the user’s computer system becomes one of the agent computer systems 130, 140, 150, 160, 170 that can be used by the cloud service 112 to execute jobs.

In some embodiments, to improve security, the cloud service 112 also requires each agent computer system and/or each user to be associated with a key-secret pair, and the key-secret pair is required to be provided as a configuration of the software agent to establish the secure communication. In some embodiments, the cloud service 112 is configured to generate the key-secret pairs.

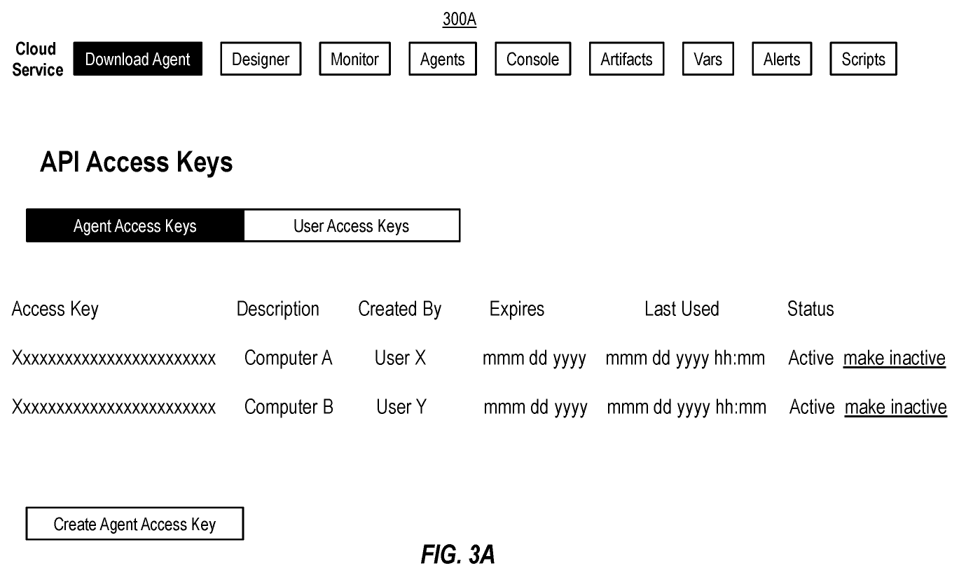

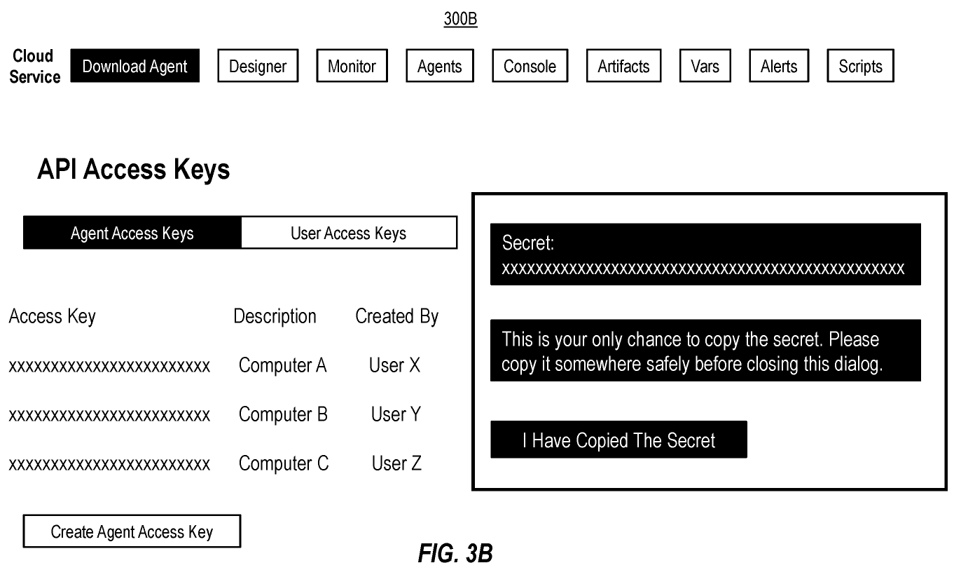

FIGS. 3A and 3B illustrate an example user interface 300A, 300B, through which the user can cause the cloud service 112 to generate a new key-secret pair, and obtain the newly generated key-secret pair. FIG. 3A illustrates a cloud service user interface 300A showing a list of agent access keys and information related to each agent access key, such as description, the user that created the key, the last used time, and status of the key. In some embodiments, the user can also set an expiration date for any key and/or deactivate the key. Each of these agent access keys has a corresponding secret that is only known to the software agent and the cloud service 112. Notably, the secret is not shown on the cloud service user interface 300A.

When a new agent computer system is to be connected to the cloud service 112, the user can request the cloud service 112 to create a new agent access key by pressing the “Create Agent Access Key” link on the cloud service user interface 300A. In response to pressing the “Create Agent Access Key” link, the cloud service 112 generates a new key-secret pair and displays it in a cloud service user interface 300B. As shown in FIG. 3B, the secret is only shown to the user once when the key-secret pair is generated, and the user needs to copy the secret and store it safely.

In some embodiments, the key-secret pair is required to be stored in a configuration file associated with the software agent. In response to executing the software agent at the agent computer system using the key-secret pair as configuration, the cloud service 112 verifies that the key-secret pair used in the configuration of the software agent matches the key-secret pair previously generated. In response to a successful verification of the key-secret pair, the cloud service 112 then establishes the secure and ongoing connection with the agent computer system.

Users must have a valid login and have current credentials (via logging in to the browser or to the API) to generate an agent access key id/secret pair. When an agent authenticates with their access key-secret pair, the agent is issued a jwt token with a 10 minute expiration - the agent is configured to “refresh” expired tokens automatically - if the user revokes an agent access key (via the browser), any agent attempting to use that access key to authenticate will be prevented from communicating with the cloud service subsequent to the next token refresh, a maximum of 10 minutes. The agent is configured to shut down if authentication to the cloud service fails.

Further, the cloud service 112 is configured to organize and manage jobs in a hierarchical manner. In particular, each job includes one or more task objects (also referred to as a task). In some embodiments, each task further includes one or more step objects (also referred to as “steps”). In some embodiments, each step further includes one or more script objects.

For each task, the cloud service 112 is configured to select at least one of the one or more agent computer systems 130, 140, 150, 160, 170, and send the task to the at least one agent computer system 130, 140, 150, 160, or 170, causing the at least one agent computer system to execute the task. After the at least one agent computer system executes (or tries to execute) the task, the at least one agent is configured to send a status of the task to the cloud service 112, and the cloud service 112 is configured to receive the status of the task from the at least one agent computer system 130, 140, 150, 160, 170.

In some embodiments, when a first agent computer system among the one or more agent computer systems 130, 140, 150, 160, 170 that was selected to execute a task fails, the cloud service 112 may be configured to select a second agent computer system among the one or more agent computer systems 130, 140, 150, 160, 170, and send the task to the second agent computer system, causing the second computer system to execute the task. After the second agent computer system executes (or tries to execute) the task, the second agent computer system is configured to send a status of the task to the cloud service 112, and the cloud service 112 is configured to receive the status of the task from the second agent computer system. In the case of a service task, the service task, initially executed on one agent, may be automatically sent to another agent. This automatic sending may occur if the agent host machine goes down while the service task is in a running state. This process may repeat as many times as necessary until the task is completed or a preset condition is met. If the cloud service attempts to deliver a task to an agent and the agent goes offline before receiving the task, or if the agent has reached its configurable “max active tasks” limit or if the task is not picked up by the agent for any other reason, the task may be automatically delivered to the next available and qualified agent (based on the task agent targeting criteria).

This behavior may depend in part on RabbitMQ dead letter queue functionality. If a message sits in a queue for more than a configurable amount of time or if a message is rejected by a consumer (and the queue is appropriately configured) RabbitMQ will forward the message to a configurable “dead letter queue.” The cloud service may include a horizontally scalable component called “AgentDeadLetterWatcher” that monitors the relevant dead letter queues for tasks that were not delivered or rejected by the target agent and may call cloud service API endpoints to re-route the task. In the case that a task cannot be delivered to an agent, whether on the first or subsequent attempts, the task will remain in “WaitingForAgent” status until a qualified agent becomes available at which point the task may be automatically routed to the agent.

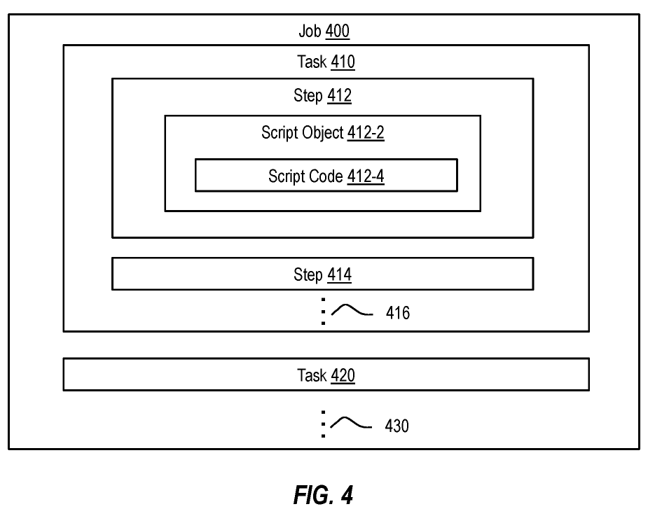

FIG. 4 illustrates an example data structure of a job 400. The job 400 includes one or more tasks 410, 420. The ellipsis 430 represents that there may be any natural number of tasks in each job. In some embodiments, each task further includes one or more steps. For example, task 410 includes steps 412, 414. The ellipsis 416 represents that there may be any natural number of steps in task 410. In some embodiments, each step further includes one or more script objects, and each script object contains script code written in a particular script language. For example, step 412 includes a script object 412-2, and the script object 412-2 contains script code 412-4 written in a particular script language, such as (but not limited to) Javascript, Shell, Python, Java, etc.

As discussed above, each task 410, 420 of a job 400 are managed by the cloud service 112, and they may be executed by different agent computer systems 130, 140, 150, 160, 170. However, the one or more steps 412, 414 of each task 410 are configured to be executed in a predetermined sequence by a same agent computer system. For example, in some embodiments, one or more steps 412, 414 of at least one task 410 includes (1) a first step 412 of installing a script interpreter or a runtime environment for a particular script language on an agent computer system among the one or more agent computer system, and (2) a second step 414 of running a script object containing script code written in the particular script language by the script interpreter or the runtime environment installed on the agent computer system. The first step 412 is a prerequisite of the second step 414, and the first step 412 and the second step 414 must be executed by a same agent computer system to achieve the intended goal of the user.

As such, a job organizes one or more tasks into a flexible workflow. In some embodiments, a job also contains instructions for how the job is to be run and stores runtime variables to be consumed during script execution. The job also contains instructions for how a set of tasks are to be run. Such instructions order the tasks, direct them to the right agent(s), pass in runtime variables and define conditions when there are alternate task routes. In some embodiments, a task also stores qualifications for which agent(s) can run the task. In some embodiments, a task also includes route codes that define how a job moves from task to task and sets conditions for alternate routing.

In some embodiments, a step, in addition to including a script object, also stores its order in the sequence and environment variables and command line arguments to be passed to script execution. In some embodiments, a step can also store a specific command to use to execute the script. Such a specific command would override the default interpreter based on the script type. For example, a command value of “usr/bin/python2.7” for a step running a python script would result in the script being executed with the interpreter located at “usr/bin/python2.7” on the machine where the step runs. Each script object contains script code that is to be executed by the interpreter and the type of interpreter to use to run the script code. As such, script objects are contained in step objects which include arguments and environment variables that can be passed to the script runtime environment. Step objects are contained in task objects, each of which can include one or more step objects. Script objects can be tied together in job objects with specific instructions on how they are to be run. A task may be contained in one and only one job and a step may be contained in one and only one task, but scripts exist independent of steps - this allows a script to be reused by any step contained in any task/job.

A job definition (also referred to as JobDef) is a structured workflow template that coordinates the execution of one or more tasks to accomplish a goal. For example, a JobDef could consist of a single task that watches for new files in a specific location. When a new file is discovered, it could launch a new job based on another JobDef with a series of tasks that constitute a data pipeline for processing the file. In some embodiments, a JobDef is designed by a user via a cloud service user interface (e.g., a browser user interface). Alternatively, or in addition, a JobDef can also be created dynamically using a cloud service 112 application programming interface (API).

JobDefs are used to create jobs, which are runtime implementations of JobDefs. Creating a job from a JobDef can be accomplished in different ways. In some embodiments, creating a job includes scheduling a JobDef using the cloud service user interface or the cloud service API. When the schedule is triggered, the jobDef will be used as a template to create and run a job. A scheduled job may be triggered but not run immediately or at all based on certain JobDef attributes. In some embodiments, a job can be launched from a JobDef manually using the cloud service API or using the cloud service user interface. In some embodiments, a JobDef can be defined in JavaScript Object Notation (JSON) and sent to the cloud service API in an HttpPOST.

In some embodiments, a JobDef also ties tasks together with routes. Different types of routes can be supported, including “from” routes and “to” routes. In some embodiments, “from” routes define the task name/route combinations that must all be satisfied to run the task with the “from” route attribute. In some embodiments, “to” routes define a list of task name/route combinations that will be launched based on completion of the task with the “to” route attribute based on the outcome (as indicated by the route) of the task with the “to” route attribute.

For example, if a task named “Run Job” has “from” routes “[[“Set up Environment”, “ok”], [Copy Input Files”, “ok″]]”, the “Setup Environment” Task would have to complete with route “ok” and the “Copy Input Files” task would have to complete with route “ok” for the “Run Job” task to be started. As another example, if the task “Run Job” has “to” routes “[[“Failed Task Handler”, “fail”}, [“Success Task Handler”, “ok”], [“Task Stats Collector”, “ok″]”, after “Run Job” completes with route “ok”, then the “Success Task Handler” and “Task Stats Collector” Tasks would both be started. If the “Run Job” task completed with route “fail” then the “Failed Task Handler” task would be started.

Task “from” and “to” routes can be defined using the cloud service API for JobDefs and jobs, and/or using the cloud service user interface. In some embodiments, task routes can be set explicitly in script code. In some embodiments, if no explicit route is defined, a default route will be assigned to the task based on the script exit code and/or signal. In some embodiments, to explicitly define a route, output a string following the pattern “@sgo{“route”, “[route name]”}” from a script object. This is similar to the syntax for dynamically generating runtime variables. In some embodiments, if multiple script objects within a task explicitly set the task route, the last one will be used.

In some embodiments, if no explicit route code is set for a task, the route will default to blank (no route) if all steps in the task are completed successfully. If a script object execution fails, as defined by completing with a non-zero exit code, the route code is automatically set to “fail”. If a script object is interrupted, either by manually pressing certain keys (e.g., ctl+c), SIGTERM or with the API, or the cloud service user interface, the route code is automatically set to “interrupt”.

In some embodiments, there are a few settings in the job definition that define conditions for how jobs are to be run. These settings include (but are not limited to) max instances, misfire grace time, coalesce, and/or pause on failed job. In some embodiments, “max instances” defines how many instances of a job can run concurrently. In some embodiments, “misfire grace time” defines how long a job can wait past a scheduled start time before it is canceled. In some embodiments, the “misfire grace time” setting applies only to jobs with schedules. In some embodiments, “coalesce” directs the cloud service 112 to skip all but one job when there are multiple jobs queued up. The “coalesce” setting is useful for scenarios where an agent has gone offline and missed the start time for several scheduled jobs. In some cases, it may be desirable to run only one instance and skip the rest. In some embodiments, the “coalesce” setting applies only to jobs with schedules. In some embodiments, “pause on failed job” is to pause a job when a job fails. For example, if “pause on failed job” is set as true, when a job created from a JobDef fails, the JobDef will be paused until it is manually resumed, or all failed tasks are either canceled or completed successfully. The “pause on failed job” setting facilitates certain workflow scenarios, for example, where all jobs created from a JobDef must complete in order. The coalesce feature can apply to both scheduled and non-scheduled JobDefs. For example, if you have a JobDef with maxinstances = 1, and you manually kick off the job once and then 4 more times before the first instance completes. When it does complete it will skip 3 of the queued instances and only run one instance of the job. When an instance of a job is skipped it may be displayed in the job monitor with status “Skipped” with the descriptive message “Job skipped due to coalesce.”

Accordingly, each job has one or more tasks. Each task can have one or more steps that are run in a set sequence. Tasks can target one or more agents. If a task targets multiple agents, each agent will run separate instances of the task in parallel. Once an agent computer system begins processing a task, all steps in the task will be completed on that agent computer system. If a task fails or is interrupted, it can be restarted. A restarted task may be executed on any qualified agent, not necessary the agent where it originally ran. Consequently, a restarted task will execute all steps in the task rather than, for example, restarting with the specific step that failed.

The steps of a specific task instance are generally required to all be completed by the same agent computer system because there are some sequences of events that cannot be shared across multiple machines. Here is an example task having two steps, including step 1, install java; and step 2, run a java application. If step 1 runs on one machine and step 2 runs on a different machine where java has not been installed, step 2 will fail. The user (e.g., a job designer) understands the logical boundaries of each discrete part of the job and designs accordingly.

Dependencies on prior task outcomes are stored in the task definition “from” routes. “From” routes determine whether the job route will route through a given task or not. Downstream dependencies are stored in the task definition “to” routes. “To” routes determine which tasks will be started when this task completes.

In some embodiments, a task definition (also referred to as TaskDef) stores the qualifications for determining which agent(s) can run the task. Those qualifications include (but are not limited to) (1) any active agent, (2) any active agent with tags as specified in the task definition, (3) all active agents, (4) all active agents with tags as specified in the task definition, and/or (5) a specific agent. In some embodiments, users can define tags, and tags are formatted in key-value pairs, such as “Linux = True”. Task tags can be defined using the cloud service user interface or the cloud service API.

In some embodiments, task definitions also keep a list of artifacts that are required to run the scripts. Artifacts can be configuration files, compiled code, data files, and/or anything else needed to run the script object in a task.

In some embodiments, a user can give the task definition a name to make it more convenient to work with. The TaskDef name should be unique among TaskDefs within the JobDef to which it belongs.

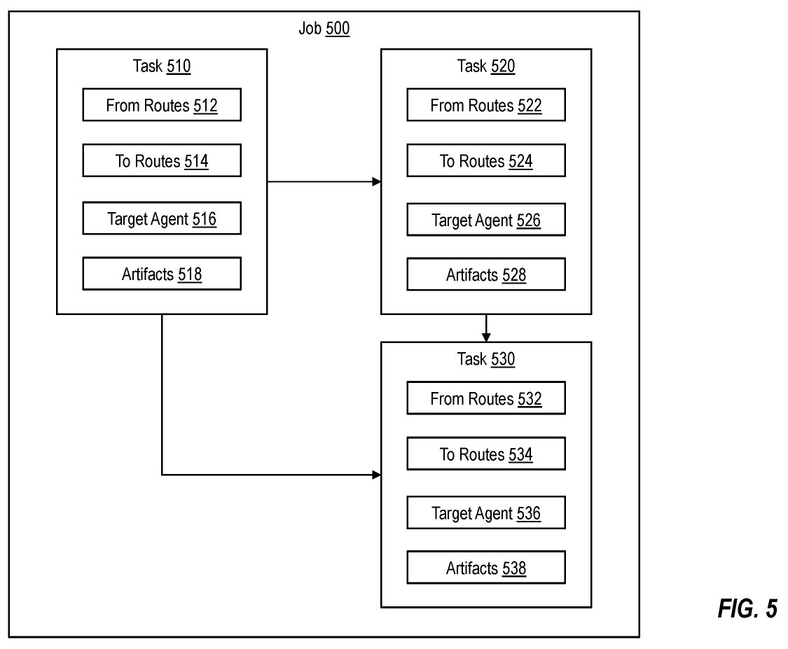

As such, a user can design a particular job to include a particular set of tasks, each of which has specific “from” routes, “to” routes, target agent, and artifacts. FIG. 5 illustrates an example workflow of a job 500, which corresponds to job 400 of FIG. 4. As illustrated, job 500 includes three tasks 510, 520, 530. Each task 510, 520, 530 includes a “from” routes attribute 512, 522, 532, a “to” routes attribute 514, 524, 534, a target agent attribute 516, 526, 536, and/or any artifact(s) 518, 528, 538. Based on the design, a particular task may be required to be executed before another task. For example, as illustrated, task 510 is required to be executed before tasks 520, 530, and task 520 is required to be executed before task 530. As such, the cloud service 112 will cause task 510 to be executed first, then task 520, and finally task 530.

Further, as discussed above with respect to FIG. 4, each task includes one or more steps. Steps are generally required to be run in a set sequence. A step definition (also referred to as StepDef) stores its order in the sequence. In some embodiments, each step can have only one script object. The step definition can store arguments or environment variables that are needed to run the script. Step arguments and environment variables can be set dynamically at runtime using runtime variables. The command attribute can be used to specify the exact interpreter to use to execute the script for steps created from this StepDef. It can also be used to set arguments that should be passed to that interpreter, e.g., to pass a classpath to the scala interpreter. If not specified, the default interpreter for the script type will be used to execute the script.

For example, if there is a script of type “python” and the “command” attribute is not set, then the default python interpreter on the machine where the step runs will be used to execute the script. If the command attribute is set to “/usr/bin/python2.7”, then the interpreter in that location on the agent computer system will be used to run the script. The interpreter specified by the command attribute needs to exist on the agent computer system on which the step runs. In some embodiments, a user can give the step definition a name to make it more convenient to work with.

Additionally, as described above with respect to FIG. 4, each step includes one script object. Each script object stores script code written in a particular script language. In some embodiments, a script object also stores useful information about the script code, such as (but not limited to) the script language, the original author, and/or who last edited it.

The cloud service 112 is configured to orchestrate the execution of any script object. In some embodiments, the script type attribute is added to the script object to make it easier to work with common scripting languages. In some embodiments, the cloud service user interface includes a script editor that provides cues based on the script language. In some embodiments, an acronym is assigned to each script language. For example, “SH” can be used if the script will run on Linux, Linux based, or Mac operating system, and “CMD” for windows and then define the “Command” attribute either in the StepDef or when executing the script object from the console. In some embodiments, different script languages are defined by an integer. For example, in some embodiments, 0= PYTHON, 1=NODE, 2=SH, 3=CMD, 4=RUBY, 5=LUA, 6=PERL, 7=PHP, 8=POWERSHELL. In some embodiments, certain script objects can also be executed from the console provided by the cloud service 112.

In some embodiments, script objects can be set to be editable within the organization. All script objects may be set to be viewable within the organization. In some embodiments, an author can give a script object a name to make it more convenient to work with. In some embodiments, the name needs to be unique within the organization or team that the user belongs to.

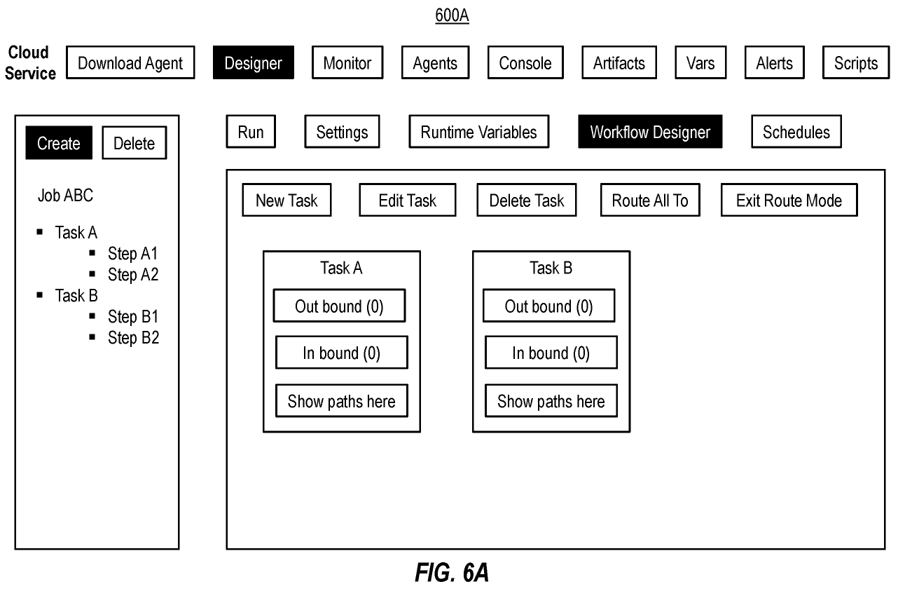

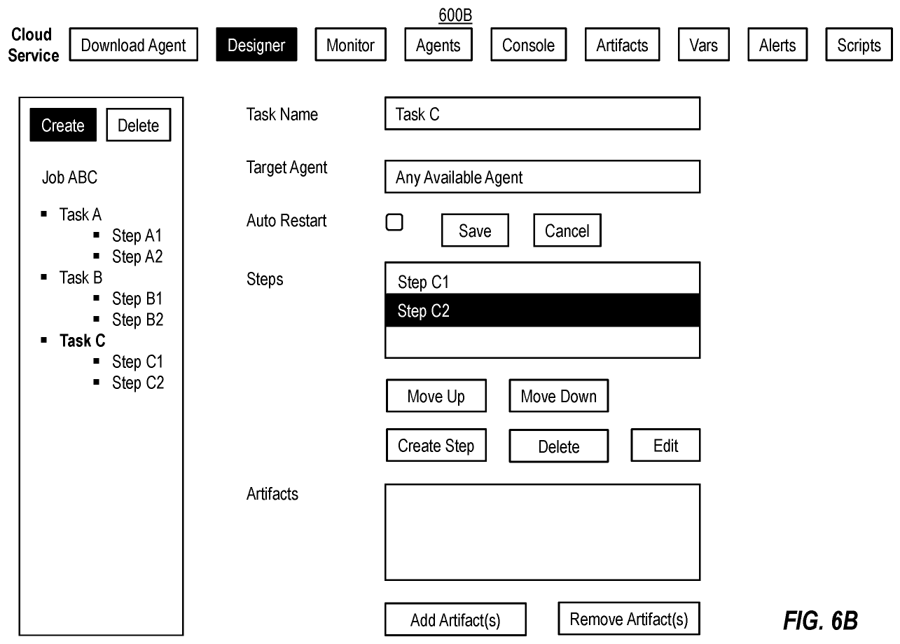

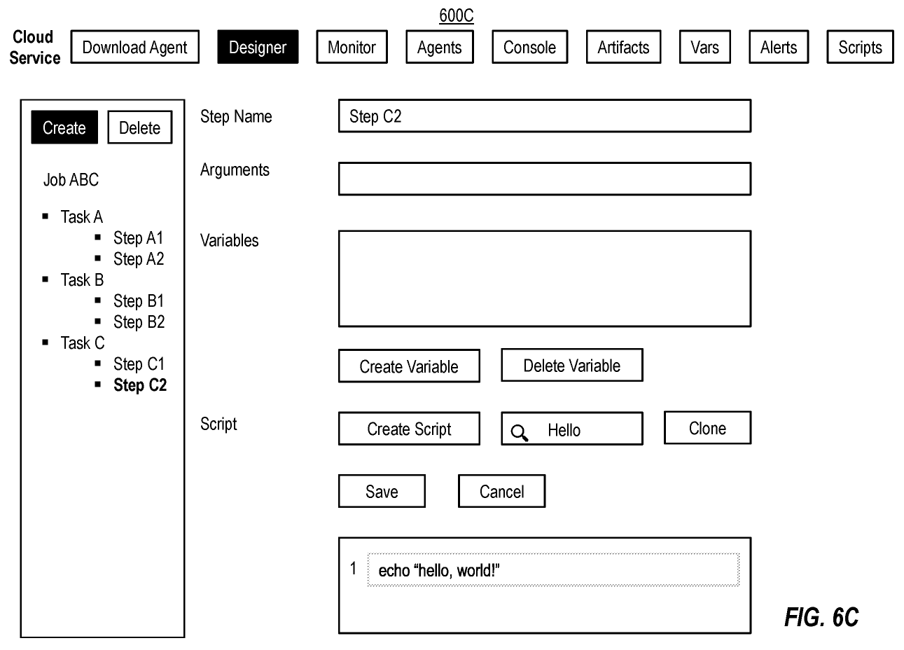

FIGS. 6A-6B illustrate an example user interface 600A, 600B, 600C configured to allow a user to create a job and its workflow. As illustrated in FIG. 6A, the user has created a Job ABC, which includes two tasks, namely Task A and Task B. When the user clicks the “new task” link, a cloud service user interface 600B of FIG. 6B will be shown. As illustrated, the user has named the new task “Task C”. The cloud service user interface 600B allows the user to set target agent(s) to be one of (1) any active agent, (2) any active agent with a specified tag, (3) all active agents, (4) all active agents with a specified tag, or (5) a specific agent. The cloud service user interface 600B also allows the user to create one or more steps for the task, and set a predetermined sequence of the steps. As illustrated, the user has created two steps, namely Step C1 and Step C2, for Task C. The user can also add or remove artifacts to Task C via the cloud service user interface 600B.

Further, when the user clicks the “edit” link for Step C2, user interface 600C of FIG. 6C will be shown. The cloud service user interface 600C allows the user to set arguments and variables for Step C2. The cloud service user interface 600C also allows the user to create a script object, and edit the script code contained in the script object.

Further, in some embodiments, job definitions can also include runtime variables. Runtime variables are key-value pairs. They provide a mechanism for dynamically injecting variable values in script code, arguments, and environment variables of a step when it is executed by an agent computer system. Runtime variables can be defined at design time on the organization level and/or in JobDefs. In some embodiments, when a job is created, runtime variables can also be generated dynamically during script execution.

In some embodiments, runtime variables can be assigned to a job when it is created and runtime variables can also be generated dynamically during script execution. JobDef scoped runtime variables can be defined in JobDefs using the cloud service user interface or the cloud service API. Job scoped runtime variables can be defined in a job when the job is created. When a job is created using the cloud service API the runtime variables can be included in the HttpPost request. When a job is created from a JobDef in the cloud service user interface the runtime variables can be entered in the job creation dialog.

Additionally, in some embodiments, the runtime variables can also be dynamically generated during script execution by printing a properly formatted string to stdout. In some embodiments, the format is “@sgo{“[variable name]”: “[variable value]”}”. For example, the following line of python script code would dynamically create or modify a runtime variable with name “myKey” and value “myValue” when executed by an agent computer system:

print ‘@sgo{“myKey”: “myValue”}’

The “myKey” runtime variable would now be defined as “myValue” for subsequent Steps in the task being executed and for subsequent tasks in the job workflow.

In some embodiments, the cloud service 112 reserves the keyword “route” to determine a route-based path between tasks in a job workflow. So the following output “@sgo{“route”: “ok″}” would not create a runtime variable named “route”. Instead, it would be used for routing from the executing task in the job workflow.

If a runtime variable is defined on multiple levels, each successively granular level overrides the previous. For example, if a variable named “key” is defined on the organizational level with a value of “org_value” and in a JobDef with a value of “jobdef_value”, the JobDef value will override the organizational value. If the variable is defined in a job created from the JobDef with a value of “job_value”, the job value will override the JobDef value. If within that job a script object runs which prints the following string to stdout “sgo{“key”: “script_value”}”, the script value will override the job value and any subsequent reference to “key” will have the value “script_value”. A subsequent script object could override the value again.

In some embodiments, runtime variables values can be dynamically injected into the script code, arguments, and environment variables of a step. Immediately before running a step of a task, an agent will search the script code arguments for strings following the pattern “sgg(“[key]”)” and will replace them with the current value of the runtime variable with the name “[key]”. If no runtime variable with the name “[key]” exists, “null” will be injected instead.

For example, if a python script with the following line of code is provided:

Print(‘The value of “myKey” is “@sgg(“myKey”)”’

And a runtime variable “myKey” with value “myValue”, the script will produce the following output:

The value of “myKey is “myValue”

As another example, if a step argument with value “@sgg(“myKey”)-out myFile.txt” is provided, and the runtime value of “myKey” is “myValue” the script code for the step will be called with arguments “myValue -out myFile.txt”.

In some embodiments, runtime variable injection for step environment variables works slightly differently. Step environment variable keys are compared to the current runtime variables for matching keys. If a match is found, the runtime variable value will be used for the environment variable value when running a script object. For example, if there is a step environment variable “myKey=” and a runtime variable “myKey” with value “myValue”, then the runtime script execution environment will have an environment variable “myKey=myValue.”

In some embodiments, a StepDef can be configured so that steps created from the StepDef utilize runtime variables using the cloud service API or the cloud service user interface. In some embodiments, the cloud service user interface provides a console, and runtime variable injection can also be utilized when running scripts using the cloud service user interface console.

In some embodiments, as scripts are executing, the corresponding stdout is monitored in real-time and searched for strings following the @sgo runtime variable generation pattern. When runtime variables are created and/or modified, the new values are sent to the could service. If a task fails and is restarted, the most recent runtime variables will be delivered with the task to the agent computer system, where the task resumes execution. Consequently, scripts can be designed to utilize the most recent value of runtime variables.

For example, if a script is designed to iterate through records in a file, the line number could be printed to stdout with a string like @sgo{“line_num”, “10″}” which would send the runtime variable “line_num” with a value of “10” to the cloud service 112. If the task failed on line “11” and the task is restarted, the script could resume processing the file on the line after “@sgg(“line_num”)″ which would now have a value of “10”. In some embodiments, this function does not apply to tasks that target multiple agents.

In some embodiments, jobs are executed based on set schedules. Schedules can be created for JobDefs to automatically trigger jobs to run. In some embodiments, a JobDef can have more than one schedule, but a schedule can be lined to one JobDef. Multiple types of schedules may be implemented. The different types of schedules include (but are not limited to) date, cron, and/or interval.

In some embodiments, a date schedule stores a single date and time for when the job will be triggered to run.

In some embodiments, a cron schedule resembles the “Cron” utility found in most Unix-like operating systems. Multiple fields are available to define a cron schedule. The multiple fields can include (but are not limited to) year, month, day, week, day of week, hour, minute, second, start date, end date, and/or jitter. The start date is the earliest possible date/time to trigger the job, and the end date is the latest possible date/time to trigger the job. Jitter is advance or delay the job execution by up to jitter seconds. A cron schedule will trigger when current time matches all specified time constraints. In some embodiments, users can omit fields of cron that you do not need.

In some embodiments, an interval schedule specifies a set amount of time that needs to lapse before a job is triggered. Multiple fields are available to define an interval schedule. The multiple fields can include (but are not limited to) weeks, days, hours, seconds, start date, end date, and/or jitter. An interval schedule will trigger a job when the time interval has been reached from the previous trigger time.

In some embodiments, an “is active” box is required to be checked to activate the schedule. In some embodiments, a user can give the schedule a name to make it more convenient to work with. Additionally, schedules may have a Runtime variable property which can be populated with key/value pairs which are passed to Jobs created by the schedule for use in Job scripts.

Notably, service jobs for different computer systems running different operating systems (e.g., Windows^{®}, Linux^{®}, Mac^{®}) work very differently. The cloud service 112 described herein makes it easy to create a service and deploy it to any operating system. As with any job, service jobs can be centrally managed and monitored with the cloud service user interface and/or the cloud service API.

In some embodiments, a service job generally can contain only one task. The task can target any qualified agent computer system or a specific agent computer system. In some embodiments, if an agent computer system running a service job goes offline for more than 65 seconds, the job can be automatically redeployed to another qualified agent computer system. If no qualified agent computer system is available, the job status will be set to “Failed.” The cloud service 112 can be configured to send a notification if a job fails.

The task in a service job can have multiple steps. A script object for the last step in the task generally should be coded so that it will not exit unless and until you want the service to be stopped. In some embodiments, service jobs that exit normally or crash are not redeployed automatically. However, if a service job is interrupted by ctrl+c or a SIGTERM/SIGKILL signal it will be automatically redeployed. Consequently, if an agent computer system running a service job task is shut down, the task will be automatically redeployed.

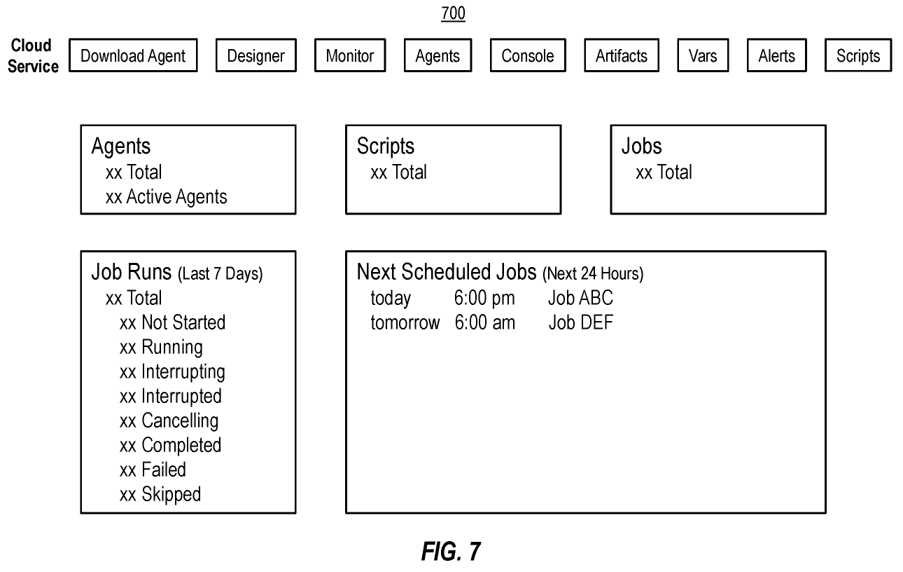

FIGS. 7-14 further illustrate examples of user interfaces that can be provided by the cloud service 112. FIG. 7 illustrates a cloud service user interface 700 showing a home screen of the cloud service 112 that provides the general status of different agents and jobs. The cloud service user interface 700 may be displayed at a browser when a user first logs into their account.

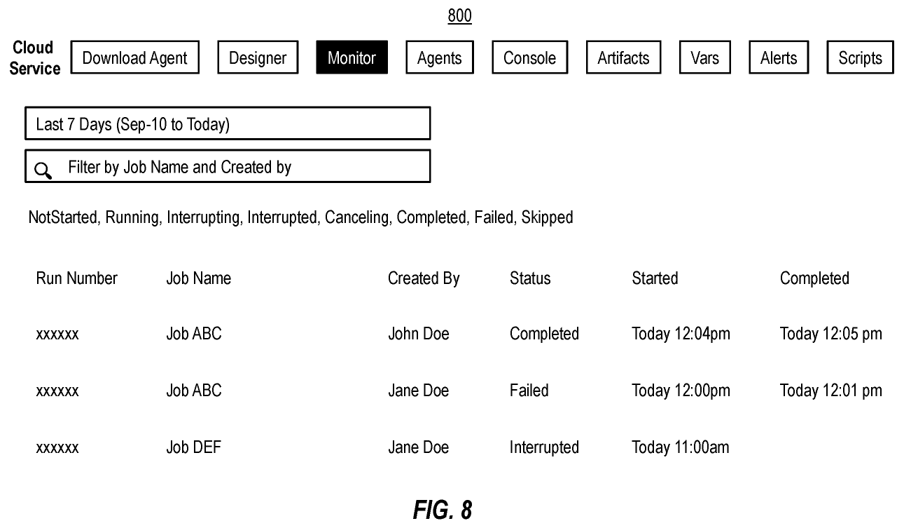

When the user clicks the “monitor” link, a cloud service user interface 800 of FIG. 8 may be displayed. The cloud service user interface 800 shows a status of each job in a list of jobs that have been executed recently. The user can further filter the jobs by time, job name, and/or created by. In some embodiments, when the user clicks a particular job, additional details about the job may be displayed.

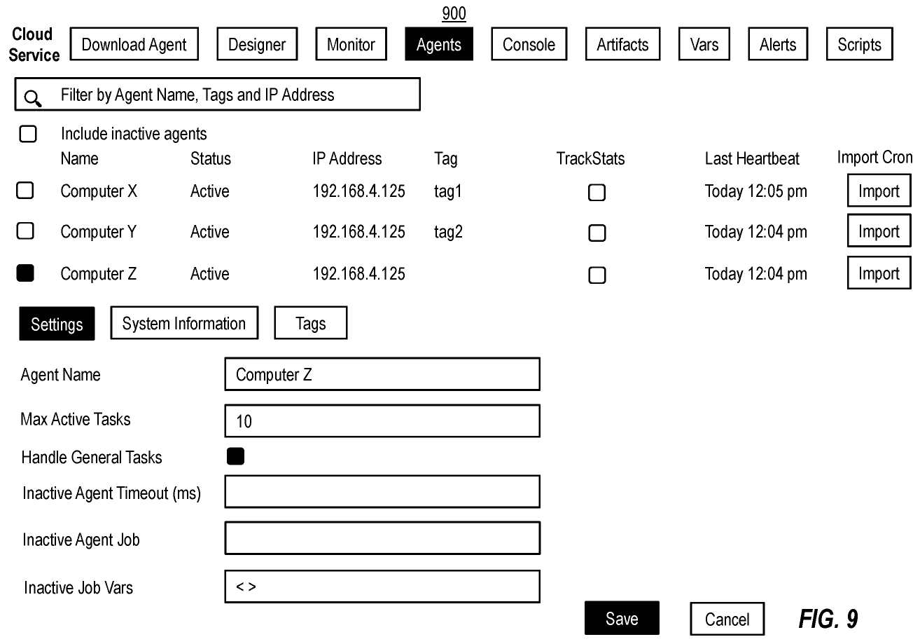

FIG. 9 illustrates a cloud service user interface 900 that shows a list of agents associated with a user, a team, and/or an organization. The user can select a particular agent to review and/or change its settings, system information, and/or tags.

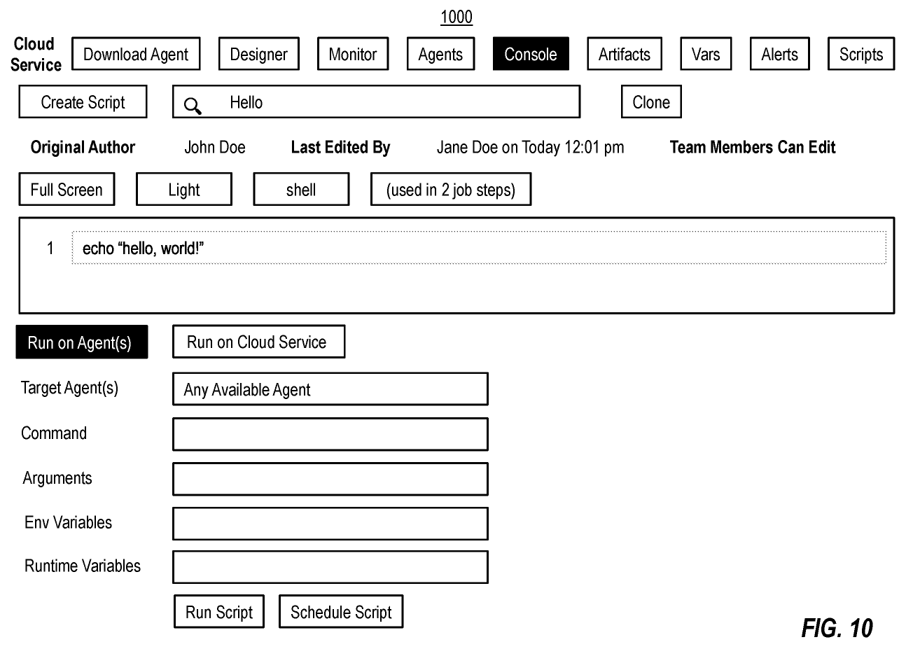

FIG. 10 illustrates a cloud service user interface 1000 that shows a console that allows a user to review, edit, create, and/or run a script object. The user can also set a target agent, command, argument(s), environment variables, runtime variables for the script. In some embodiments, the user can also select to run the script object on the cloud service 112, which can be a virtual machine or an additional computing service provided by the cloud service 112.

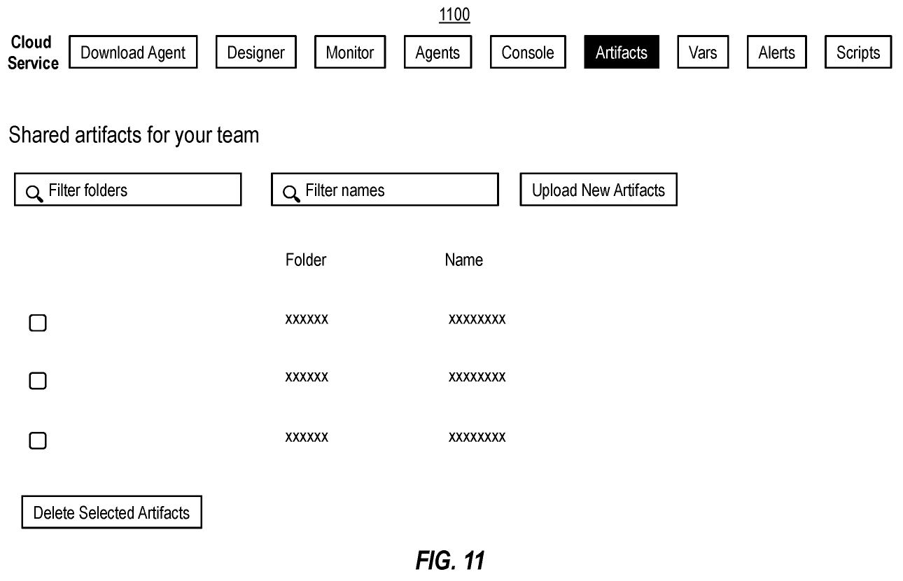

FIG. 11 illustrates a cloud service user interface 1100 that shows a list of artifacts shared for a user’s team. The user can delete an existing artifact, or upload a new artifact. Artifacts can be configuration files, compiled code, data files (e.g., image files, video files, audio files, etc.), and/or anything else needed to run the script object in a task.

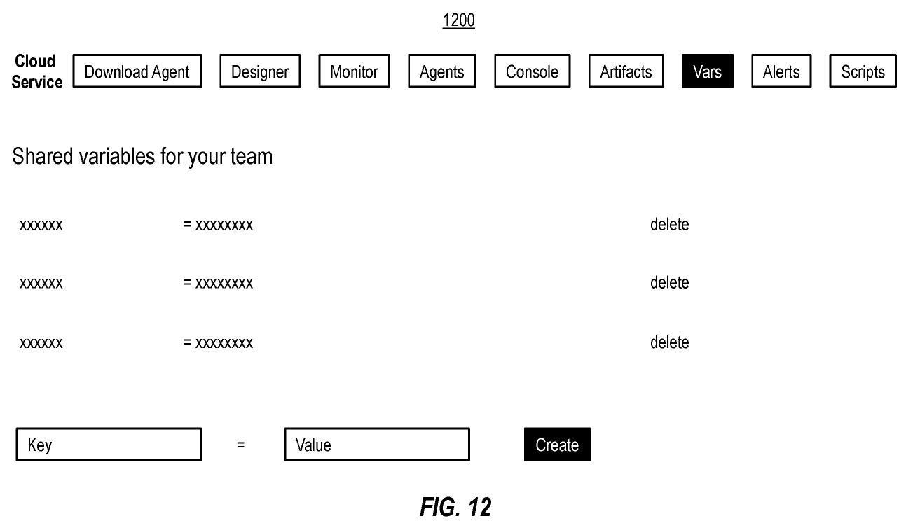

FIG. 12 illustrates a cloud service user interface 1200 that shows a list of variables shared for a user’s team. Each variable is a key-value pair. The user can delete existing variables, and/or create new variables from the cloud service user interface 1200.

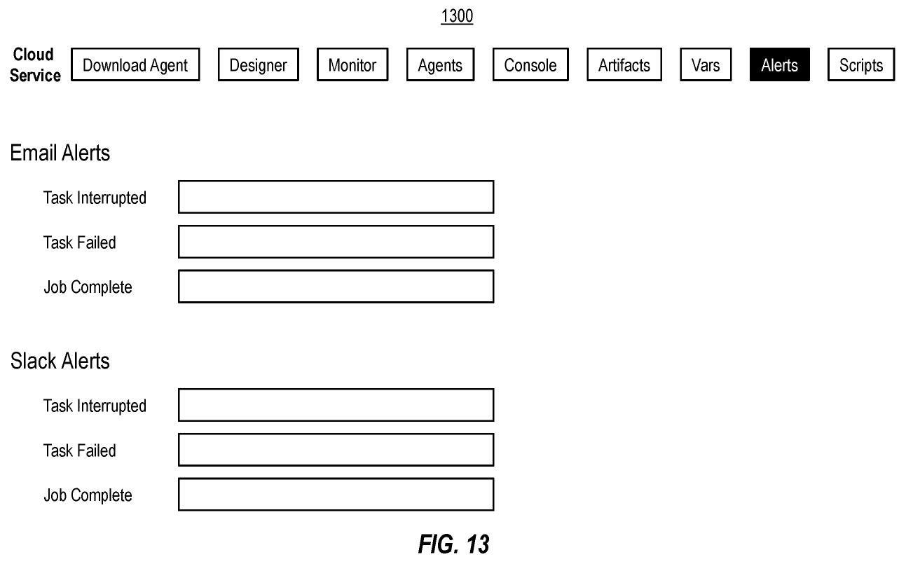

FIG. 13 illustrates a cloud service user interface 1300 that allows a user to set email alerts and/or slack alerts when a task is interrupted, a task is failed, and/or a job is completed.

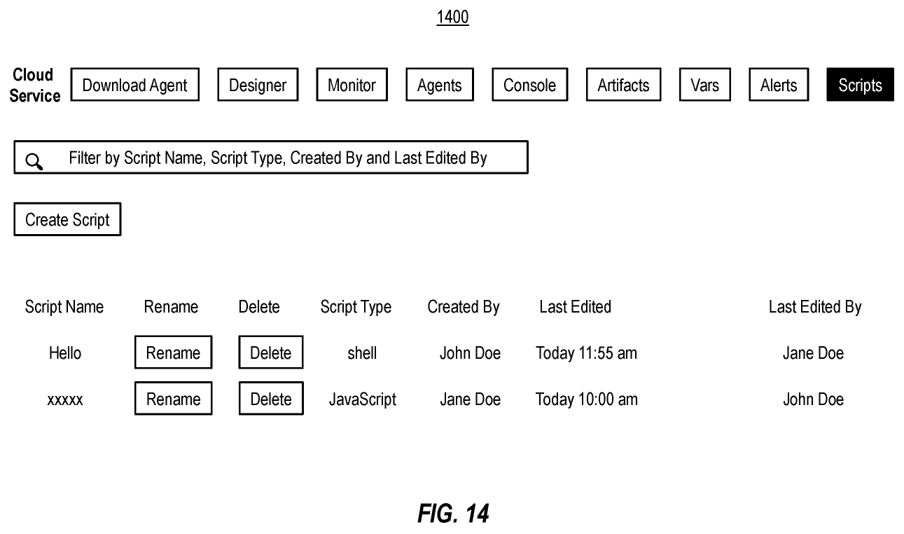

FIG. 14 illustrates a cloud service user interface 1400 that shows a list of script objects. A user can delete and/or edit existing script objects and/or create new script objects via the cloud service user interface 1400.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

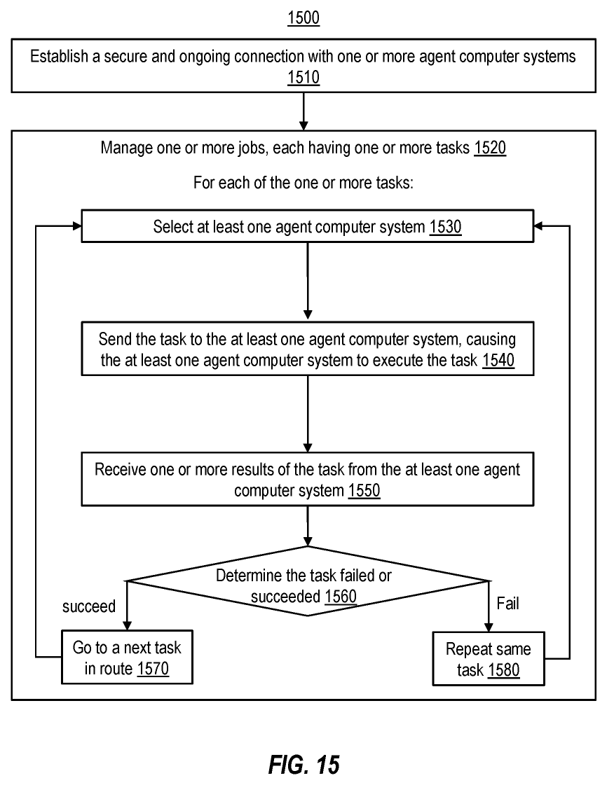

FIG. 15 illustrates a flowchart of an example method 1500 for orchestrating one or more jobs that are executed or to be executed by one or more agent computer systems, which may be performed by a cloud service 112 hosted at a server computer system 110 of FIG. 1. The method 1500 includes establishing a secure and ongoing connection with one or more agent computer systems (act 1510) and managing one or more jobs, each of which has one or more tasks (act 1520). The act 1520 includes for each of the one or more tasks, selecting at least one of the one or more agent computer systems (act 1530) and sending the task to the at least one agent computer system, causing at least one agent computer system to execute the task (act 1540). After executing the task, the at least one agent computer system sends the status of the task to the cloud service 112, and the cloud service 112 receives one or more results of the task from the at least one agent computer system (act 1550). Based on the status of the task, the cloud service 112 determines whether the task failed (act 1560).

In response to determining that the task failed, the cloud service 112 may, if configured by the user to do so, cause the task to be repeated again (act 1580), which includes selecting at least one agent computer system again (act 1530) and sending the task to the at least one agent computer system, causing the at least one agent computer system to execute the task (act 1540). Further, a failed task may be manually restarted using the web console or the API. If a task is routed to an agent but that particular agent does not attempt to process the task, the cloud service may automatically “re-route” the task to another qualified agent. The at least one agent computer system this time might be the same or different from the at least one agent computer system of the previous time. On the other hand, in some embodiments, in response to determining that the task is completed successfully, the cloud service 112 goes to a next task in route (act 1570), which includes selecting at least one agent computer system (act 1530) and sending the next task to the at least one agent computer system, causing the at least one agent computer system to execute the next task (act 1540). Again, the at least one agent computer system selected for executing the next task may be the same or a different agent computer system selected for executing the previous task. This process may repeat until all the tasks of all the jobs are complete successfully.

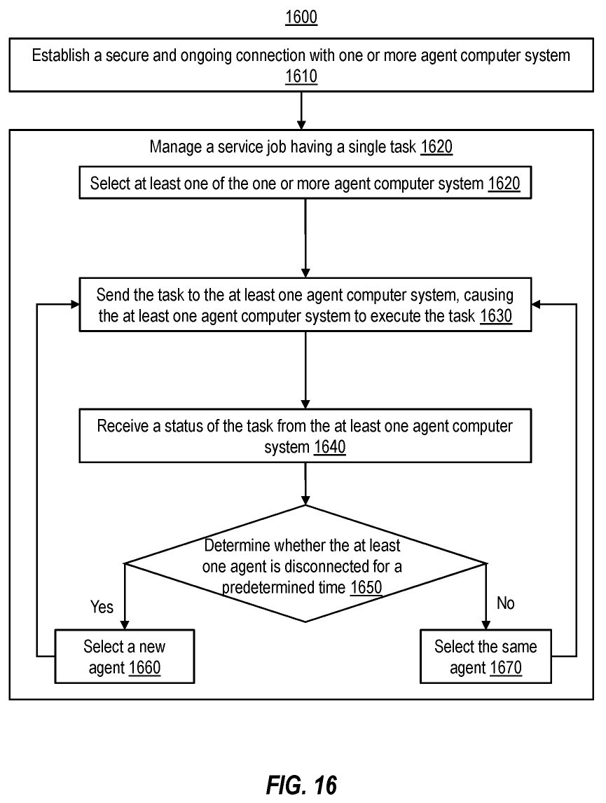

In some cases, a job is a service job, which includes a single task. FIG. 16 illustrates an example method 1600 for managing a service job having a single task that is executed or to be executed by one or more agent computer systems. The method 1600 may also be performed by a cloud service 112 hosted at a server computer system 110 of FIG. 1. The method 1600 includes establishing a secure and ongoing connection with one or more agent computer systems (act 1610) and managing the service job having the single task (act 1620). The act 1620 further includes selecting at least one of the one or more agent computer systems (act 1620) and sending the task to the at least one agent computer system, causing the at least one agent computer system to execute the task (act 1630). After executing the task, the at least one agent computer system sends a status of the task to the cloud service 112, and the cloud service 112 receives the status of the task from the at least one agent computer system (act 1640). In response to receiving the status of the task, the cloud service 112 determines whether the at least one agent is disconnected for a predetermined time (act 1650).

In response to determining that the at least one agent is disconnected for the predetermined time, the cloud service 112 selects at least one new agent (act 1660) and sends the task to the at least one new agent computer system, causing the at least one agent computer system to execute the task (act 1630). In response to determining that the at least one agent is disconnected for less than the predetermined time, i.e., the at least one agent was disconnected earlier, but has been reconnected again, a task that is still running on that agent which has been re-routed to another agent, will be canceled. The intent is to ensure that auto-restart tasks are not duplicated on multiple agents. To further clarify, if an auto-restart task (aka “service job”) is running on an agent and the agent loses connectivity to the cloud service, the cloud service will re-route the task to another agent. In this case, however, the task is now running on two agents, one being the offline agent. When the offline agent re-establishes connectivity to the cloud service, the cloud service will now cancel the task running on the previously offline agent which will result in the task running on only one agent, the new agent.

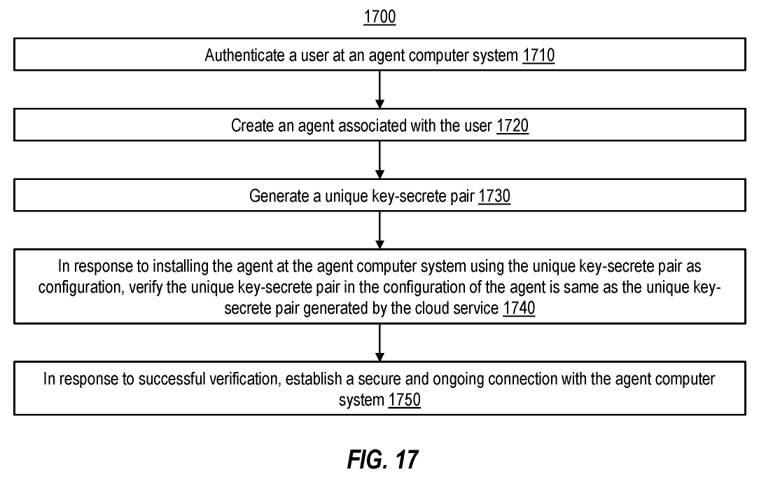

FIG. 17 illustrates a flowchart of an example method 1700 for secure connecting to an agent computer system over a network, which corresponds to act 1510 or act 1610 and may be performed by a cloud service 112 hosted at a server computer system 110 of FIG. 1. The method 1700 includes authenticating a user at the agent computer system (act 1710). In response to authenticating the user at the agent computer system, the cloud service 112 is configured to create an agent associated with the user (act 1720) and generating a key-secret pair (act 1730). In response to installing the software agent at the agent computer system using the key-secret pair as configuration, the cloud service 112 verifies whether the key-secret pair in the configuration of the software agent is same as the key-secret pair generated by the cloud service 112 (act 1740). In response to the successful verification, the cloud service 112 establishes a secure and ongoing connection with the agent computer system (act 1750).

Although the subject matter has been described in language specific to structural features and/or methodological acts, it is to be understood that the subject matter defined in the appended claims is not necessarily limited to the described features or acts described above, or the order of the acts described above. Rather, the described features and acts are disclosed as example forms of implementing the claims.

The present invention may comprise or utilize a special-purpose or general-purpose computer system that comprises computer hardware, such as, for example, one or more processors and system memory, as discussed in greater detail below. Configurations within the scope of the present invention also comprise physical and other computer-readable media for carrying or storing computer-executable instructions and/or data structures. Such computer-readable media can be any available media that can be accessed by a general-purpose or special-purpose computer system. Computer-readable media that store computer-executable instructions and/or data structures are computer storage media. Computer-readable media that carry computer-executable instructions and/or data structures are transmission media. Thus, by way of example, and not limitation, configurations of the invention can comprise at least two distinctly different kinds of computer-readable media: computer storage media and transmission media.

Computer storage media are physical storage media that store computer-executable instructions and/or data structures. Physical storage media comprise computer hardware, such as RAM, ROM, EEPROM, solid state drives (“SSDs”), flash memory, phase-change memory (“PCM”), optical disk storage, magnetic disk storage or other magnetic storage devices, or any other hardware storage device(s) which can be used to store program code in the form of computer-executable instructions or data structures, which can be accessed and executed by a general-purpose or special-purpose computer system to implement the disclosed functionality of the invention.

Transmission media can comprise a network and/or data links which can be used to carry program code in the form of computer-executable instructions or data structures, and which can be accessed by a general-purpose or special-purpose computer system. A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer system, the computer system may view the connection as transmission media. Combinations of the above should also be comprised within the scope of computer-readable media.

Further, upon reaching various computer system components, program code in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be comprised in computer system components that also (or even primarily) utilize transmission media.

Computer-executable instructions comprise, for example, instructions and data which, when executed at one or more processors, cause a general-purpose computer system, special-purpose computer system, or special-purpose processing device to perform a certain function or group of functions. Computer-executable instructions may be, for example, binaries, intermediate format instructions such as assembly language, or even source code.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The invention may also be practiced in distributed system environments where local and remote computer systems, which are linked (either by hardwired data links, wireless data links, or by a combination of hardwired and wireless data links) through a network, both perform tasks. As such, in a distributed system environment, a computer system may comprise a plurality of constituent computer systems. In a distributed system environment, program modules may be located in both local and remote memory storage devices.

Those skilled in the art will also appreciate that the invention may be practiced in a cloud-computing environment. Cloud computing environments may be distributed, although this is not required. When distributed, cloud computing environments may be distributed internationally within an organization and/or have components possessed across multiple organizations. In this description and the following claims, “cloud computing” is defined as a model for enabling on-demand network access to a shared pool of configurable computing resources (e.g., networks, servers, storage, applications, and services). The definition of “cloud computing” is not limited to any of the other numerous advantages that can be obtained from such a model when properly deployed.

A cloud-computing model can be composed of various characteristics, such as on-demand self-service, broad network access, resource pooling, rapid elasticity, measured service, and so forth. A cloud-computing model may also come in the form of various service models such as, for example, Software as a Service (“SaaS”), Platform as a Service (“PaaS”), and Infrastructure as a Service (“IaaS”). The cloud-computing model may also be deployed using different deployment models such as private cloud, community cloud, public cloud, hybrid cloud, and so forth.

Some configurations, such as a cloud-computing environment, may comprise a system that comprises one or more hosts that are each capable of running one or more virtual machines. During operation, virtual machines emulate an operational computing system, supporting an operating system and perhaps one or more other applications as well. In some configurations, each host comprises a hypervisor that emulates virtual resources for the virtual machines using physical resources that are abstracted from view of the virtual machines. The hypervisor also provides proper isolation between the virtual machines. Thus, from the perspective of any given virtual machine, the hypervisor provides the illusion that the virtual machine is interfacing with a physical resource, even though the virtual machine only interfaces with the appearance (e.g., a virtual resource) of a physical resource. Examples of physical resources including processing capacity, memory, disk space, network bandwidth, media drives, and so forth.

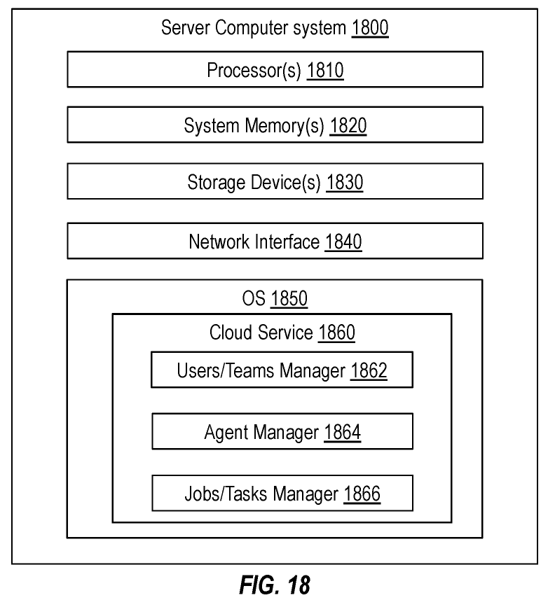

FIG. 18 illustrates an example architecture of a server computer system 1800, which corresponds to the server computer system 110 of FIG. 1. The server computer system 1800 includes one or more processors 1810, one or more system memories 1820, one or more storage devices 1830, and a network interface 1840. The network interface 1840 is configured to allow the server computer system 1800 to be connected to a network (e.g., network 120 of FIG. 1). An operating system 1850 is stored on the one or more storage devices 1830 and loaded in the one or more system memories 1820. A cloud service 1860 (which is a service application) is installed and executed in the operating system 1850 configured to establish secure communication with one or more agent computer systems. In some embodiments, the cloud service 1860 includes a users/teams manager 1862, an agent manager 1864, and a jobs/tasks manager 1866. The users/teams manager 1862 is configured to manage different users and teams. The software agent manager 1864 is configured to manage different software agents and their corresponding agent computer systems. The jobs/tasks manager 1866 is configured to manage and orchestrate different jobs and/or tasks.

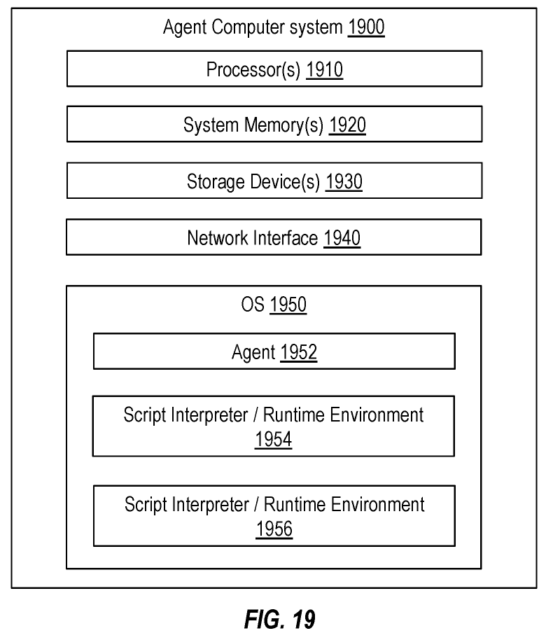

FIG. 19 illustrates an example architecture of an agent computer system 1900, which corresponds to the agent computer system 130, 140, 150, 160, or 170 of FIG. 1. The agent computer system 1900 includes one or more processors 1910, one or more system memories 1920, one or more storage devices (1930), and a network interface 1940. The network interface 1940 is configured to allow the agent computer system 1900 to be connected to a network (e.g., network 120 of FIG. 1). An operating system 1950 is stored in the one or more storage devices 1930 and loaded in the one or more system memories 1920. A software agent 1952 and one or more script interpreter and/or runtime environments 1954, 1956 are installed on the operating system 1950. The software agent 1952 is configured to establish secure communication with the cloud service 1860 hosted on the service computer system 1800 and direct different script code contained in tasks (received from the cloud service) to proper interpreters and/or runtime environment 1954, 1956.

For the processes and methods disclosed herein, the operations performed in the processes and methods may be implemented in differing order. Furthermore, the outlined operations are only provided as examples, and some of the operations may be optional, combined into fewer steps and operations, supplemented with further operations, or expanded into additional operations without detracting from the essence of the disclosed embodiments.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method performed by a cloud service for orchestrating one or more jobs that are to be executed by one or more agent computer systems, each job comprising one or more tasks, the method comprising:
establishing a secure and ongoing connection with the one or more agent computer systems over a network;
for each task,
selecting at least one of the one or more agent computer systems;
sending the task to the at least one agent computer system, causing the at least one agent computer system to execute the task; and
in response to executing the task by the at least one agent computer system, receiving execution status of the task from the at least one agent computer system.

2. The method of claim 1, wherein secure and ongoing connection with the one or more agent computer systems are established via Hypertext Transfer Secure Protocol (HTTPS).

3. The method of claim 1, wherein:
each of the one or more agent computer systems is associated with a key-secret pair;
the association of each agent computer system and the key-secret pair are registered with the cloud service; and
establishing the secure and ongoing connection with the one or more agent computer systems over the network comprises:
for each of the one or more agent computer systems,
in response to executing a software agent at the software agent computing system with a key-secret pair as a configuration of the software agent, verifying that the key-secret pair used in the configuration of the software agent matches the key-secret pair registered with the cloud service; and
in response to successful verification of the key-secret pair, establishing the secure and ongoing connection with the agent computer system.

4. The method of claim 1, wherein the method further comprising:
when a first agent computer system among the one or more agent computer systems that was selected to execute a task fails,
selecting a second agent computer system among the one or more agent computer systems;
sending the task to the second agent computer system, causing the second computer system to execute the task; and
receiving status of the task from the second agent computer system.

5. The method of claim 1, wherein the job is a service job having a single task, and the method further comprising:
when the secure connection between a first agent computer system among the one or more agent computer systems running the service job and the cloud service is disconnected for more than a predetermined time,
selecting a second agent computer system among the one or more agent computer systems;
sending the task to the second agent computer system, causing the second computer system to execute the task; and
receiving one or more results of the task from the second agent computer system.

6. The method of claim 1, wherein each task includes one or more steps, each step includes one or more script objects, and each script object contains script code written in a particular script language, and
wherein the one or more steps of each task are configured to be executed in a predetermined sequence by a same agent computer system.

7. The method of claim 6, wherein the one or more steps of at least one task includes:
a first task of installing a script interpreter or a runtime environment for a particular script language on an agent computer system among the one or more agent computer system, and
a second task of running a script object containing script code written in the particular script language by the script interpreter or the runtime environment installed on the agent computer system.

8. The method of claim 1, wherein at least one job among the one or more jobs includes one or more settings, including at least one of (1) max instances, (2) misfire grace time, (3) coalesce, or (4) pause on failed job.

9. The method of claim 1, wherein at least one task includes at least one of (1) one or more runtime variables, (2) optional environment variables, (3) program arguments, or (4) artifacts consisting of a plurality of computer files required for code execution.

10. The method of claim 1, wherein at least one task among the one or more tasks includes one or more qualifications for determining which agent can run the task, the one or more qualifications including at least one of (1) any active agent, (2) any active agent with a specified tag, (3) all active agent, (4) all active agents with a specified tag, or (5) a specific agent.

11. The method of claim 1, wherein the method further comprises setting a schedule for each job, the schedule including at least one of (1) a date schedule, (2) a cron schedule, or (3) an interval schedule.

12. The method of claim 1, wherein at least one task includes a “from” route attribute or a “to” route attribute, the “from” route attribute defining one or more other tasks that are required to be executed before running the at least one task, and the “to” route attribute defining one or more other tasks that are not allowed to be executed until the at least one task is executed.

13. The method of claim 1, wherein the method further comprises:
displaying a cloud service user interface on a browser;
receiving a first runtime variable from the cloud service user interface;
injecting the first runtime variable into at least one task of at least one job among the one or more jobs.

14. The method of claim 13, wherein the method further comprises:
collecting a second plurality of runtime variables output by the at least one task;
storing the second plurality of runtime variables relationally with the at least one job; and
displaying the second plurality of runtime variables on the cloud service user interface.

15. The method of claim 13, wherein:
each of the one or more agent computer systems is associated with a user or an organization including one or more users, and
the method further comprises in response to authenticating a user associated with an agent computer system or a user of the organization via a browser, causing the cloud service user interface to be displayed at the browser.

16. The method of claim 1, wherein each of the one or more agent computer systems is one of (1) a physical machine, (2) a virtual machine, (3) a container, or (4) an embedded platform, and
each of the one or more agent computer systems runs at least one of following operating systems: (1) windows, (2) linux, (3) Mac, (4) Alpine, or (4) FreePSD.

17. A server computer system for orchestrating jobs executed or to be executed by one or more remote agent computer systems, each job comprising one or more tasks that are to be executed by one or more agent computer systems, comprising:
one or more processors; and
one or more computer-readable hardware storage devices having stored thereon computer-executable instructions that are structured such that, when executed by the one or more processors, configure the server computer system to perform at least:
establish a secure and ongoing connection with the one or more agent computer systems over a network;
for each task,
select at least one of the one or more agent computer systems;
send the task to the at least one agent computer system, causing the at least one agent computer system to execute the task; and
in response to executing the task by the at least one agent computer system, receive execution status of the task from the at least one agent computer system.

18. The server computer system of claim 17, wherein:
each of the one or more agent computer systems is associated with a key-secret pair;
the association of each agent computer system and the key-secret pair are registered with the server computer system; and
establishing the secure and ongoing connection with the one or more agent computer systems over the network comprises:
for each of the one or more agent computer systems,
in response to executing a software agent at the software agent computing system with a key-secret pair as a configuration of the software agent, verifying that the key-secret pair used in the configuration of the software agent matches the key-secret pair registered with the server computer system; and
in response to successful verification of the key-secret pair, establishing the secure and ongoing connection with the agent computer system.

19. The server computer system of claim 17, the server computer system further configured to:
when a first agent computer system selected to execute a task fails,
select a second agent computer system among the one or more agent computer systems;
send the task to the second agent computer system, causing the second computer system to execute the task; and
receive one or more results of the task from the second agent computer system.

20. The server computer system of claim 17, wherein the job is a service job having a single task, and the server computer system is further configured to:
when the secure connection between a first agent computer system among the one or more agent computer systems running the service job and the server computer system is disconnected for more than a predetermined time,
select a second agent computer system among the one or more agent computer systems;
send the task to the second agent computer system, causing the second computer system to execute the task; and
receive one or more results of the task from the second agent computer system.
